(19) United States
(12) Patent Application Publication
(10) Pub. No.: US 2016/0291821 A1
(43) Pub. Date: Oct. 6, 2016

(54) GENERATING AND DISPLAYING GRAPHICAL REPRESENTATIONS OF PROCESSES

(71) Applicant: Microsoft Technology Licensing, LLC, Redmond, WA (US)

(72) Inventors: Gregory Scott Feiges, Bellevue, WA (US); Stavros Stratoudis, Bellevue, WA (US)

(21) Appl. No.: 14/679,065

(22) Filed: Apr. 6, 2015

(51) Int. Cl. G06F 3/0484; G06F 9/48

(52) U.S. Cl. CPC G06F 3/0484; G06F 9/4881

(57) ABSTRACT

A process creation engine is provided that allows a business to create and model business processes. Users can create business processes using the engine by defining various objects and data flows of the process. The particular objects and data flows of the process, and any proposed changes, can be discussed and voted on using the engine through a portal. The engine can model the process, and any proposed changes, to identify any problems that may result from the proposed changes. In addition, once the process has been approved, the engine can be used to view the statuses of each of the objects of the process in order to determine the overall completion status of the process.

### BACKGROUND

Modern business processes may include a variety of interconnected data flows across a variety of different objects and boundaries. For example, a modern business process such as creating and selling a software application may include inputs from a variety of groups and departments such as marketing, management, packaging and distribution, and engineering. Each of these groups may further include sub-groups and sub-departments working on particular aspects of the software application.

As may be appreciated, each group or sub-group may rely on data or outputs generated by other groups or subgroups. However, using current solutions, it may be difficult to visualize how the groups and subgroups of the process are interrelated. Accordingly, when a group wants to implement a change to an aspect of the process, it may be difficult to determine which groups will be affected by the change, and it may be difficult to model how the proposed change will affect the overall performance of the process. In addition, as work on the process continues it may be difficult to easily identify particular groups or aspects of the process that are falling behind or that are ahead of schedule. Such information may be useful in determining how resources should be allocated among the groups or subgroups that are working on the process.

### SUMMARY

A process creation engine is provided that allows a business to create and model business processes. Users can create business processes using the engine by defining various objects and data flows of the process. The particular objects and data flows of the process, and any proposed changes, can be discussed and voted on using the engine through a portal. The engine can model the process, and any proposed changes, to identify any problems that may result from the proposed changes. By identifying the problems before the particular objects are programed or implemented, costly fixes may be avoided. In addition, once the process has been approved, the engine can be used to view the statuses of each of the objects of the process in order to determine the overall completion status of the process.

In an implementation, a process is generated. A plurality of objects is generated for the process. For each object of the plurality of objects, a plurality of tasks is generated for the object. A request to view a graphical representation of the process is received. In response to the request, a completion status for each task is determined. For each object, a completion status is determined for the object based on the determined completion statuses of the plurality of tasks generated for the object. A graphical representation of each object is displayed. The graphical representation of each object indicates the completion status of that object.

In an implementation, the creation of a process is initiated. A plurality of objects is defined for the process. For each object of the plurality of objects, a plurality of stakeholders is selected for the object. For each object of the plurality of objects, the object is displayed in a first manner that indicates that the object is under consideration. For each object of the plurality of objects, the object is submitted for approval to the plurality of stakeholders selected for the object. An indication of approval for a first object of the plurality of objects is received from the plurality of stakeholders selected for the first object. In response to the indication of approval, the first object is displayed in a second manner that indicates that the first object has been approved. An indication of a change is received for a second object of the plurality of objects from the plurality of stakeholders selected for the second object. In response to receiving the indication of a change for the second object, the second object is resubmitted with the change for approval to the plurality of stakeholders selected for the second object.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for process modeling;

FIG. 2 is an illustration of an example user interface through which a user may create a process;

FIG. 3 is an illustration of an example user interface showing a process;

FIG. 4 is an illustration of an example user interface showing a process;

FIG. 5 is an illustration of a user interface through which a user may determine the status of each of the various objects of a process;

FIG. 6 is an illustration of a user interface through which a user may view an object of a process;

FIG. 7 is an illustration of a user interface through which a user may view one or more tasks of an object;

FIG. 8 is an illustration of a user interface through which a user may view one or more sub-tasks of a task;

FIG. 9 is an illustration of a method for displaying a graphical representation of a process and one more associated objects;

FIG. 10 is an illustration of a method for displaying a graphical representation of a process and one more associated objects; and

FIG. 11 shows an exemplary computing environment in which example embodiments and aspects may be implemented.

### DETAILED DESCRIPTION

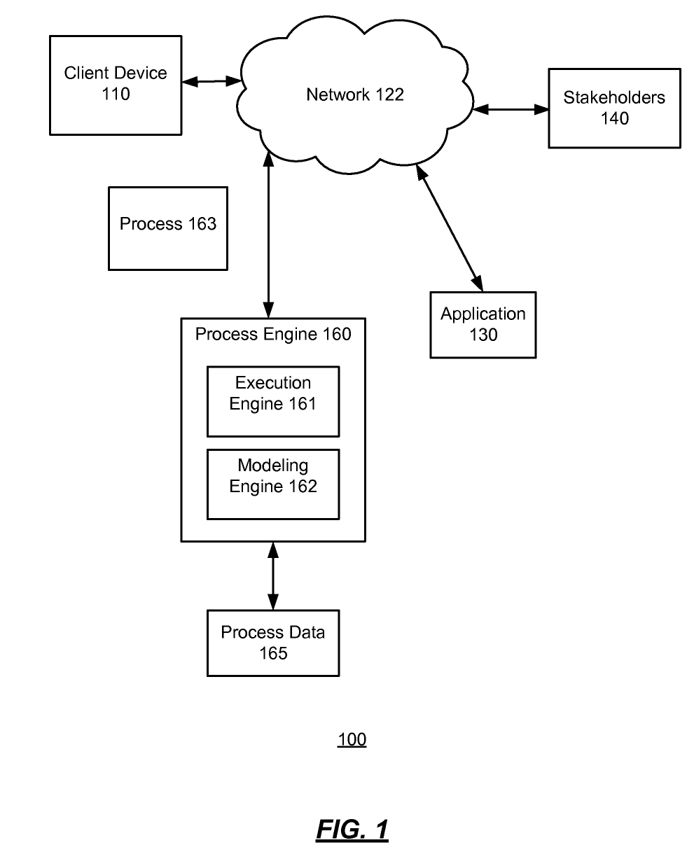

FIG. 1 is an illustration of an exemplary environment 100 for process modeling. The environment 100 may include a client device 110 and a process engine 160 in communication through a network 122. The network 122 may be a variety of network types including the public switched telephone network (PSTN), a cellular telephone network, and a packet switched network (e.g., the Internet). Although only one client device 110 and process engine 160 are shown in FIG. 1, there is no limit to the number of client devices 110 and process engines 160 that may be supported.

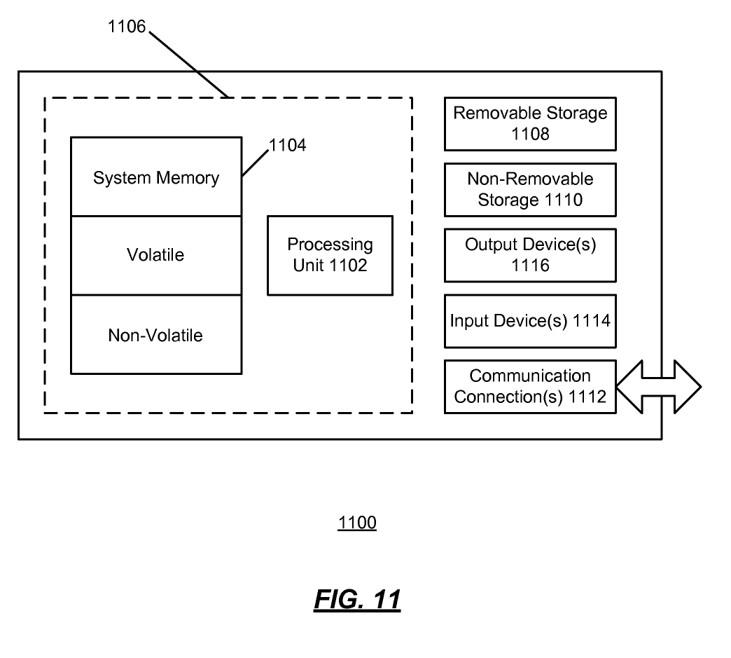

Both the client device 110 and the process engine 160 may be implemented together or separately using a general purpose computing device such as is the computing device 1100 described with respect to FIG. 11. The client device 110 may be a smart phone, video game console, laptop computer, set-top box, personal/digital video recorder, or any other type of computing device.

The process engine 160 may allow one or more users to generate, visualize, model, publish, and implement one or more business processes 163. Depending on the implementation, the process engine 160 may provide these features through an application programming interface (“API”) through which the client devices 110 may interact with the process engine 160. A business process 163, or simply process 163, as used herein may refer to a collection of objects or tasks that may be completed in order to satisfy a business goal. An example of a business process 163 may be a business process 163 that results in the creation and sale of a software application. Other types of business processes 163 may be supported.

The process engine 160 may include an execution engine 161. The execution engine 161 may allow a user to create or define a process 163 by first defining objects that may make up the process 163. An object may be a high-level construct that represents a particular goal that may be completed to advance the process 163. Depending on the implementation, an object may further include one or more tasks that are to be completed as part of the business process. Example high level objects may include marketing or engineering, for example. In some implementations, each object may be associated with a different group or unit within an organization associated with the process 163.

In some implementations, each object may be associated with a plurality of attributes. The attributes associated with an object may be metadata and may include a variety of information about the object such as name, type, creation date, the name of the process 163 associated with the object, as well as identifiers of the tasks and sub-tasks that may make up the particular object. Other attributes may be supported.

In addition, each object may further identify one or more of what are referred to as “stakeholders” 140. A stakeholder 140 may be a user who is responsible for overseeing or implementing the particular object. The stakeholder or stakeholders associated with an object may be identified using email addresses or other contact addresses. The stakeholders 140 may include managers responsible for the overseeing the completion of the object, as well as engineers or programmers that will ultimately create the object.

When a user initially creates a business process 163, the user may be presented with a user interface through which the user can initially select or define an object for the process 163. While the user can customize and define objects as desired, initially the user may be presented with a list or dropdown box of suggested objects. The objects in the suggested objects may be based on the object selection history of all of the users of the execution engine 161, or just the particular user that is creating the current process 163. Alternatively or additionally, the suggested objects may be set by an administrator.

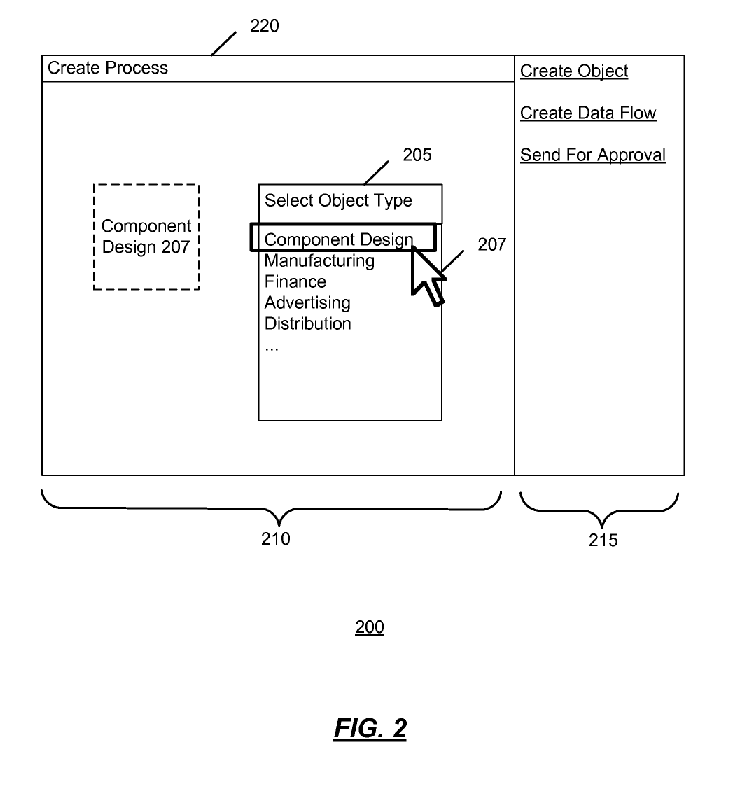

For example, FIG. 2 is an illustration of an example user interface 200 through which a user may create a process 163. The user interface 200 includes a region 210 through which the user may create and define the objects that define the process 163, and a region 215 through which various options related to the creation of the process 163 are displayed to the user. The user interface 200 also includes a region 220 that orients the user and indicates to the user that the purpose of the user interface 200 is to create a process. In the example shown, the region 215 includes options for the user to “create object”, “create data flow”, and “send for approval”. In some implementations, the contents of the region 215 may be customizable and may allow a user or users to include content such as custom graphics or links to web pages or internal documents that may be relevant to the process 163. Any type of content may be supported.

As shown, a user is using a pointer 207 to select an object for the process 163 from a list 205 of preselected objects. After selecting the option “Component Design”, a component design 207 object has been created and displayed in the region 210. As will be described further below, the component design 207 object is initially displayed using a broken line to indicate to the user that the object is tentative or under consideration. Other graphical indicators may be used.

Depending on the implementation, the attributes associated with a selected or created object may initially be pre-populated by the execution engine 161 of the process engine 160. For example, the attributes may be populated using external data associated with one or more applications 130 typically associated with the object, may be populated based on one or more business rules or logic, may be populated based on a history of object and attribute definitions associated with the user, or may be predetermined by an administrator.

Each object and the associated attributes may be stored by the execution engine 161 of the process engine 160 in the process data 165. The process data 165 may be a database, or other data structure, that is used to store each object associated with a process 163. Depending on the implementation, each application 130 may be able to directly create and store objects in the process data 165 through the API provided by the execution engine 161 of the process engine 160. These objects may then be selected and used in one or more processes 163 by the user.

The execution engine 161 may further allow the user to create and define data flows between the objects of the process. A data flow may represent the flow of data from one object of the business process 163 to another object of the business process 163. Each data flow may have at least one input and at least one output. Similar to the objects, each data flow may be associated with its own attributes. Depending on the implementation, the user may select the data flows from a list of data flows that are associated with each object. Alternatively or additionally, the user may define their own data flows. Applications 130 may also directly create and store data flows using the API provided by the execution engine 161.

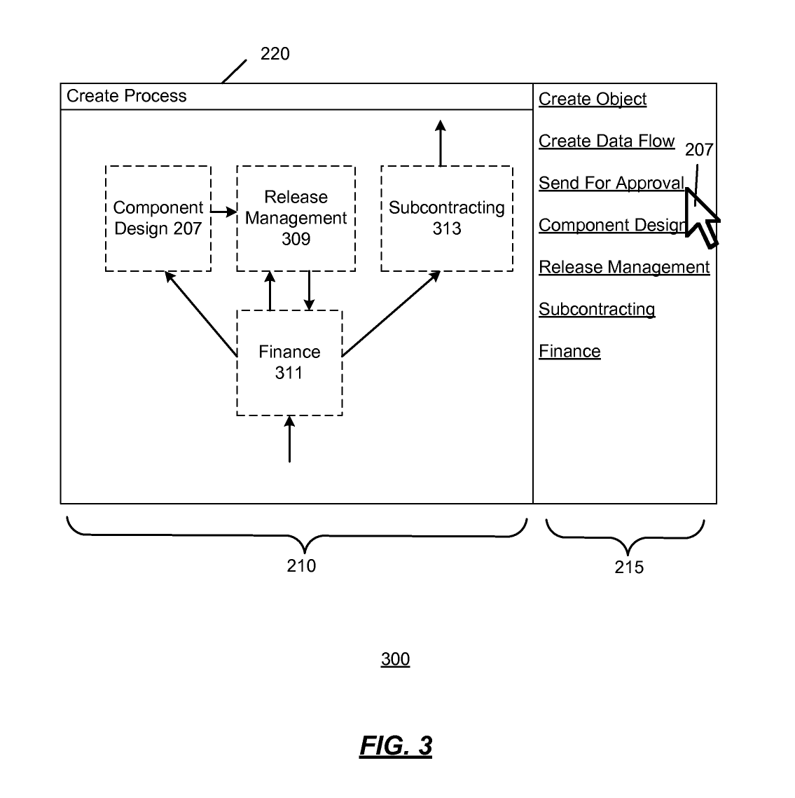

Continuing the example above, FIG. 3 is an illustration of a user interface 300 showing a process 163 that has been created by the user using the execution engine 161. The created process 163 includes four objects including the component design 207 object, the release management 309 object, the subcontracting 313 object, and the finance 311 object. The user has also added multiple data flows to the process 163 that are represented by the arrows shown in the region 220 connecting the various objects. The direction of an arrow may indicate the direction of the particular data flow associated with the arrow. For example, the arrow between the finance 311 object and the subcontracting 313 object represents a data flow from the finance 311 object to the subcontracting 313 object.

After completing the objects and data flows of the process 163, the user may use the execution engine 161 to enter a review phase where the user may request that each stakeholder 140 associated with an object and/or the process 163 review and vote on the particular object. The stakeholders 140 may vote on the objects including any attributes and associated data flows proposed for the process 163. As shown, the various objects of the process 163 are displayed in the region 210 using dotted lines to indicate that they have not yet been approved.

Depending on the implementation, the execution engine 161 may enter the review phase by generating a portal or webpage though which each stakeholder 140 may review the process 163, may make any changes or edits to the process 163, or may vote to approve the process 163. Continuing the example above, the user may request that the stakeholders 140 review the process 163, or a particular object of the process 163, by selecting the link labeled “send for approval” in the region 215 using the pointer 207.

After selecting the link, each of the stakeholders 140 associated with the process 163 may receive an email, or other communication, instructing them to review or comment on the objects of proposed process 163. The email may include a link to the portal through which the stakeholders 140 can review and discuss the objects of the process 163. In some implementations, each stakeholder 140 is able to vote on each object associated with the process 163, as well as provide any suggested edits or changes to the objects or process 163 using the portal. The changes suggested by the various stakeholders 140 may be presented as one or more layers overlaying the process 163 in the region 210. The stakeholders 140 may then discuss and vote on proposed changes using the portal.

The process engine 160 may further include a modeling engine 162. The modeling engine 162 may allow the user or stakeholders 140 to model the proposed process 163. The modeling engine 162 may model the process 163 by simulating the performance of the objects and data flows that make up the process 163. Based on the modeling, the modeling engine 162 may identify any possible issues or problems that may be associated with any of the objects and/or data flows that make up the process 163. For example, by modeling the process 163 the modeling engine 162 may identify mismatches in the types of data generated or expected by one or more of the objects of the process 163.

Depending on the implementation, the modeling engine 162 may generate a score for the process that may be based on one or more business rules or business logic. The score may reflect the speed or efficiency at which a particular process 163 operates. In general, high process scores are better than low process scores.

Depending on the implementation, the modeling engine 162 may model the process 163 before and after any proposed changes are made to the objects or data flows of the process 163. The resulting scores can be compared to help determine whether a proposed change improves or impairs the overall performance of the process 163.

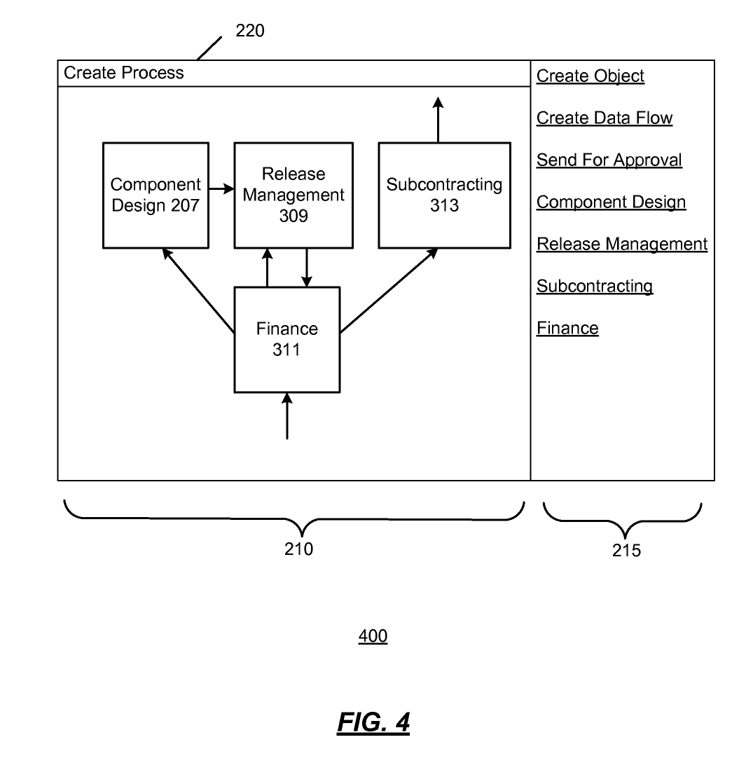

After a majority of the stakeholders 140 have approved the process 163, or each object of the process 163, the process 163 may be finalized. Continuing the example above, FIG. 4 is an illustration of a user interface 400 showing a final process 163. As shown, the various objects of the process 163 are now illustrated using continuous lines, rather than broken, to indicate to the user that process 163 has now been finalized. Any subsequent additions or changes may be sent to the stakeholders 140 for approval similarly as described above.

After being finalized, the various objects of the process 163 may be released for completion by the execution engine 161. In some implementations, the execution engine 161 may notify the various stakeholders 140 associated with the process 163 that the process 163 has been finalized. Each stakeholder 140 may then begin implementing their associated object.

Depending on the implementation, the stakeholders 140 associated with a particular object may begin creating and or defining the various tasks and sub-tasks that may be necessary to complete the object. The stakeholders 140 associated with a particular object may generate, discuss, and vote on each task or sub-task similarly as described above for the process 163. Alternatively, the tasks and sub-tasks may have already be determined as part of the initial object creation and review.

After releasing the process 163 for completion, the user may desire to determine the status of the process 163. Accordingly, the execution engine 161 may allow the user to view the completion status of the process 163, including the particular completion statuses of the objects and tasks that make up the process 163.

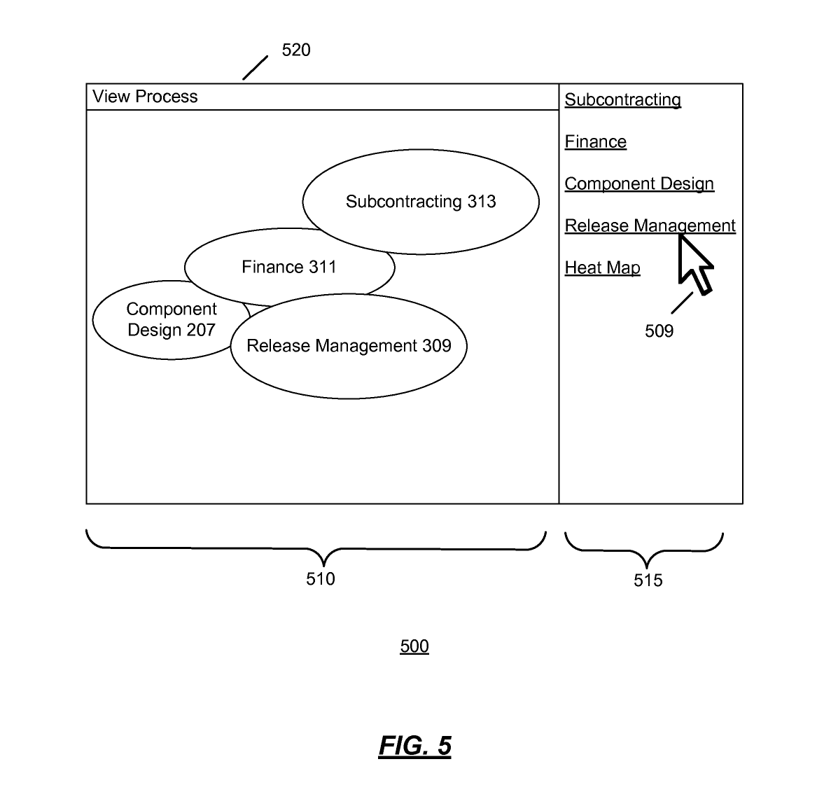

FIG. 5 is an illustration of a user interface 500 through which the user may determine the status of each of the various objects of the process 163. The user interface 500 includes a region 510, a region 520, and a region 515. The region 510 may include representations of the objects that make up the process 163. The objects include the component design 207 object, the finance 311 object, the release management 309 object, and the subcontracting 313 object. The region 520 may orient the user by indicating to the user that they are viewing the entire process 163, and may be later used to indicate to the user the particular object, task, or sub-task that the user is viewing. The region 515 may include one or more links or options that the user may select using the pointer 509. Similar to the region 215, the region 515 may be customized to include links to a variety of web pages or other documents.

In the example shown, the objects of the process 163 are illustrated in the region 510 as overlapping shapes to illustrate to the user the relationship or data flows between the various objects. For example, the component design 207 object is shown as overlapping both the finance 311 object and the release management 309 object to illustrate that the component design 207 object has data flows with both of the finance 311 object and the release management 309 object.

The objects may also be displayed in the region 510 in a way that indicates to the user the approximate completion status of each object. In some implementations, the objects may be displayed using colors where each color indicates an approximate completion status of each object. For example, if the component design 207 object is 100% compete it may be displayed in green, and if the finance 311 object is 0% complete it may be displayed in red. Other graphical indicators may be used to indicate completion status including gradients or icons, for example. The particular option to display the completion status of the objects is referred to herein as the “heat map” and may be selected by the user using the pointer 509 and the corresponding link in the region 515.

In some implementations, the execution engine 161 may generate the heat map by, for each object, determining the completion status of the various tasks and sub-tasks that make up the particular object. The completion statuses of the tasks and sub-tasks may be stored in the process data 165 with the various object attributes. The completion statuses of the tasks and sub-tasks may be periodically provided by the stakeholders 140 associated with the tasks and/or sub-tasks.

In some implementations, the completion status of an object may be determined using the completion statuses of the various tasks and sub-tasks and business logic. The business logic may indicate how important each task or sub-task is to the overall completion status of the object. For example, one task may be considered important and may require more programming or resources to complete than a lesser task, and therefore the completion status of the important task may factor more in the calculation of the completion status of the corresponding object than the completion status of the lesser task. The business logic may be based on metadata such as the attributes associated with the objects in the process data 165. The particular business rules used to calculate the completion status of an object may be set by an administrator or the user that created the process 163.

The execution engine 161 may further allow the user to “drill-down” or view the various data flows, tasks and sub-tasks that are associated with each of the objects of the process 163. Continuing the example from FIG. 5, the user may desire to view more information about the release management 505 object. Accordingly, the user may use the pointer 509 to select the link corresponding to the release management 309 object in the region 515, or may use the pointer 509 to select the release management 309 object in the region 510.

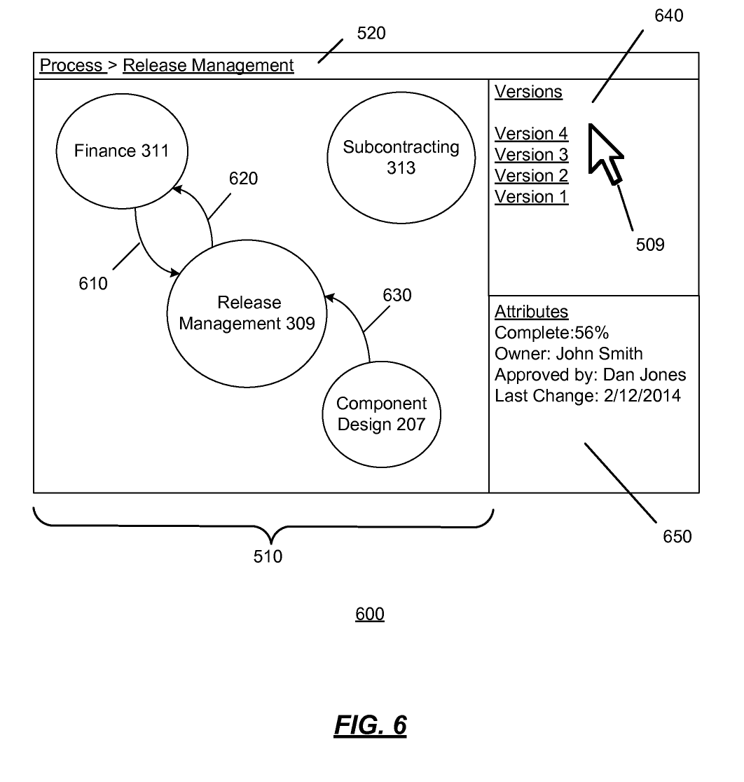

In response to the selection, the execution engine 161 may generate and display the user interface 600 of FIG. 6. As shown in FIG. 6, the region 510 of the user interface 600 shows the various objects of the process 163 as they relate to the selected release management 309 object. For example, the release management 309 object is shown in the center of the region 510 surrounded by the other objects of the process 163. The data flow interactions between the release management 309 object, the finance 311 object, and the component design 207 object are shown by the arrows 610, 620, and 630. There are no interactions between the subcontracting 313 object and the release management 309 object in the process 163, and therefore no arrows are illustrated.

As shown, the region 520 has been updated to reflect that that the user is viewing the release management 309 object of the process 163. The user may return to the view shown in the user interface 500 by selecting the “process” link in the region 520.

The user interface 600 may further includes the regions 640 and 650. The region 640 may include links to the various versions of the release management 309 object that are available for the user to view. As shown, there are four different versions of the release management 309 object. Each version may be stored by the execution engine 161 in the process data 165.

The region 650 may display some or all of the attributes associated with the selected release management 309 object of the process 163. The attributes may be extracted from the process data 165 by the execution engine 161. The attributes shown in the region 650 include the completion percentage, identifiers of the stakeholder(s) 140 that “own” or are in charge of the object, identifiers of the stakeholder(s) 140 that approved the object, and a date that the object was last changed or updated. Other attributes may displayed. The particular attributes shown in the region 650 may be selected by the user or may be set by an administrator.

The user may desire to view more information about the tasks that make up the most recent version of the release management 309 object. Accordingly, the user may use the pointer 509 to select the “Version 4” link in the region 640. Alternatively, the user may use the pointer 509 to directly select the release management 309 object in the region 510 to view the most recent version.

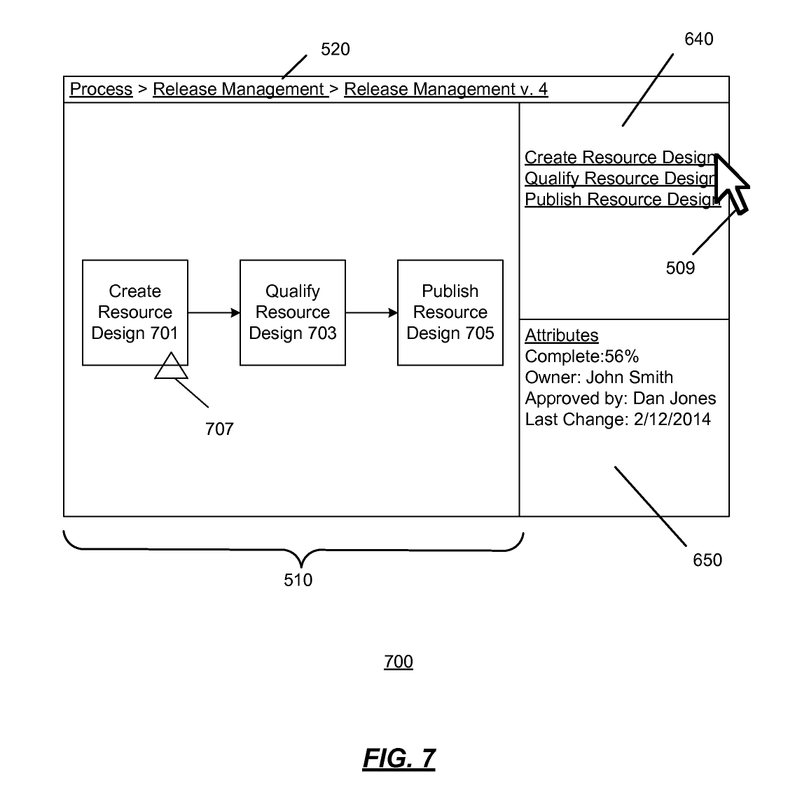

In response to the selection, the execution engine 161 may generate and display the user interface 700 of FIG. 7. As shown in FIG. 7, the region 510 of the user interface 700 shows the various tasks that make up the selected version of the release management 309 object. The tasks that make up the release management 309 object may be determined by the execution engine 161 from attributes associated with the release management 309 object in the process data 165. The tasks shown include create resource design 701, qualify resource design 703, and publish resource design 705. The arrows between the various tasks represent data flows between the tasks.

The region 640 has been updated to show links to the various tasks that are displayed in the region 510. The region 650 continues to display the attributes associated with the release management 309 object. The region 520 has been updated to reflect that the user is now viewing version 4 of the release management 309 object. The user may return to the previously displayed user interface 600 to view a different object version by selecting “Release Management” in the region 520, or may return to the user interface 500 to select a different object of the process 163 by selecting “Process” in the region 520.

The tasks may be displayed in the user interface 700 in such a way as to indicate to the user to the completion status of the tasks, or to indicate problems or errors associated with the data flows associated with the task. In the example shown, the create resource design 701 task is shown with a graphical indicator 707 that is meant to indicate to the user that the task is not complete. The displayed graphical indicator 707 is a triangle, but other graphical indicators may be used such as changing the shape and/or color of the task.

The user may desire to learn more about the create resource design 701 task associated with the graphical indicator 707 and may use the pointer 509 to select “Create Resource Design” in the region 640. Alternatively, the user may directly select the create resource design 701 task in the region 510.

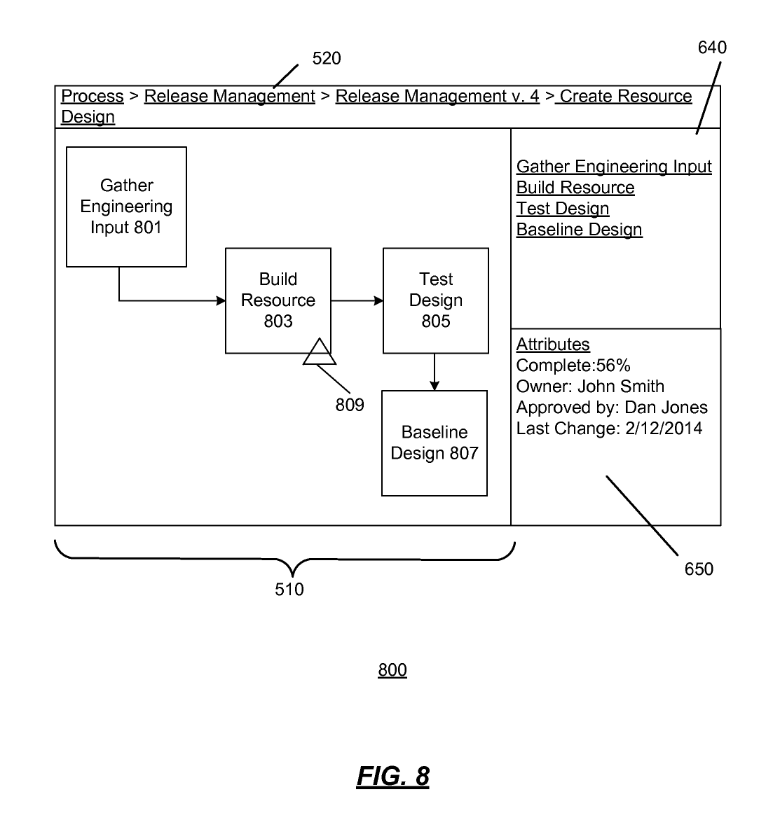

In response to the selection, the execution engine 161 may generate and display the user interface 800 of FIG. 8. As shown in FIG. 8, the region 510 of the user interface shows the various sub-tasks that make up the selected create resource design 701 task. The sub-tasks include gather engineering input 801, build resource 803, test design 805, and baseline design 807. Similarly as with the user interface 700, the arrows between the various sub-tasks represent data flows between the tasks.

The region 640 has been updated to show links to the various sub-tasks that are displayed in the region 510. The region 650 continues to display the attributes associated with the release management 309 object. The region 520 has been updated to reflect that the user is now viewing the create resource design task of the release management 309 object. The user may return to any of the previously displayed user interfaces by selecting the corresponding heading the region 520.

Similarly as shown in the user interface 700, a graphical indicator 809 is displayed on the build resource 803 sub-task to indicate that the particular sub-task is not complete or has issues. The user may view more information about any of the sub-tasks displayed in the region 510 by selecting any of the displayed sub-tasks.

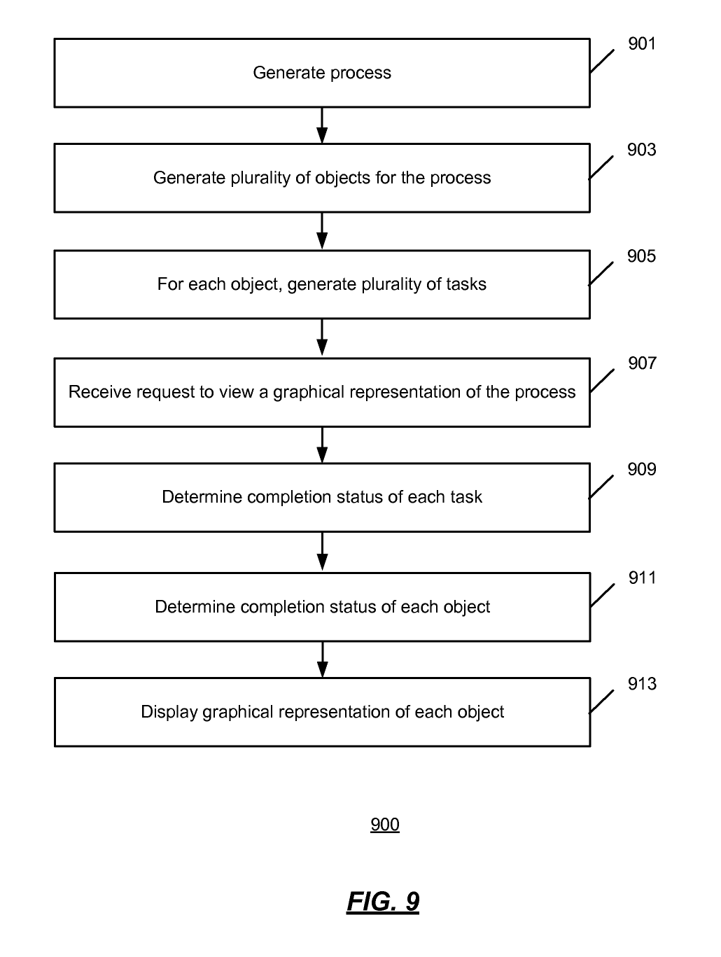

FIG. 9 is an illustration of a method 900 for displaying a graphical representation of a process and one more associated objects. The method may be implemented by the execution engine 161 of the process engine 160.

At 901, a process is generated. The process 163 may be generated by a user using the execution engine 161. In some implementations, the user may generate the process 163 using a user interface 200 provided by the execution engine 161 by selecting a title or name for the process 163. The execution engine 161 may then generate an entry for the process 163 in the process data 165.

At 903, a plurality of objects is generated for the process. The plurality of objects may be generated for the process by the user using the execution engine 161. In some implementations, the user may select each object for a process 163 from a list or other user interface element. The objects may be selected from a plurality of objects made available by the execution engine 161. Depending on the implementation, each object may have one or more attributes that may be defined by the user, or may be predefined based on metadata or other information provided by one or more applications 130, for example. In addition, each object may be associated with one or more stakeholders 140. The stakeholders 140 associated with an object may be responsible for the object including implementing the object. The objects generated for the process 163 may be stored by the execution engine 161 in the process data 165.

At 905, for each object of the plurality of objects, a plurality of tasks are generated for the object. The tasks may be generated for an object by the user using the execution engine 161. Depending on the implementation, the tasks for an object may also be generated by the stakeholders 140 associated with the object. The task generated for each object may be stored by the execution engine 161 in the process data 165.

At 907, a request to view a graphical representation of the process is received. The request may be received by the execution engine 161 from the user that created the process 163. In some implementations, the requested graphical representation is a heat map that indicates the completion status of the various objects that were generated for the process 163. Some amount of time may have passed since the user created the process 163, and the user may desire to determine if the process 163 is nearing completion, or if resources may need to be reallocated between objects of the process 163.

At 909, in response to the request, a completion status of each of the tasks is determined. The completions statuses of each task may be determined by the execution engine 161 based on completion information about each task in the process data 165. The completion information may have been provided by one or more of the stakeholders 140 associated with each task, for example.

At 911, for each object, a completion status of the object is determined. The completion status of an object may be determined by the execution engine 161 based on the completion statuses of all the tasks associated with the object. In some implementations, the execution engine 161 may further determine the completion station of an object using business logic or rules for calculating the status of the object. For example, the business logic may weigh the completion statuses of more difficult or complicated tasks higher when calculating the completion status of the object than easier or less difficult tasks.

At 913, a graphical representation of each object is displayed. The graphical representation of each object may be displayed by the execution engine 161 using a user interface that is similar to the user interface 500. Each graphical representation may be stylized to graphically indicate to the user the completion status of the objects. For example, the objects may be displayed using colors, shadings, text, or icons that indicate to the user the completion status of the objects. Other graphical techniques may be used.

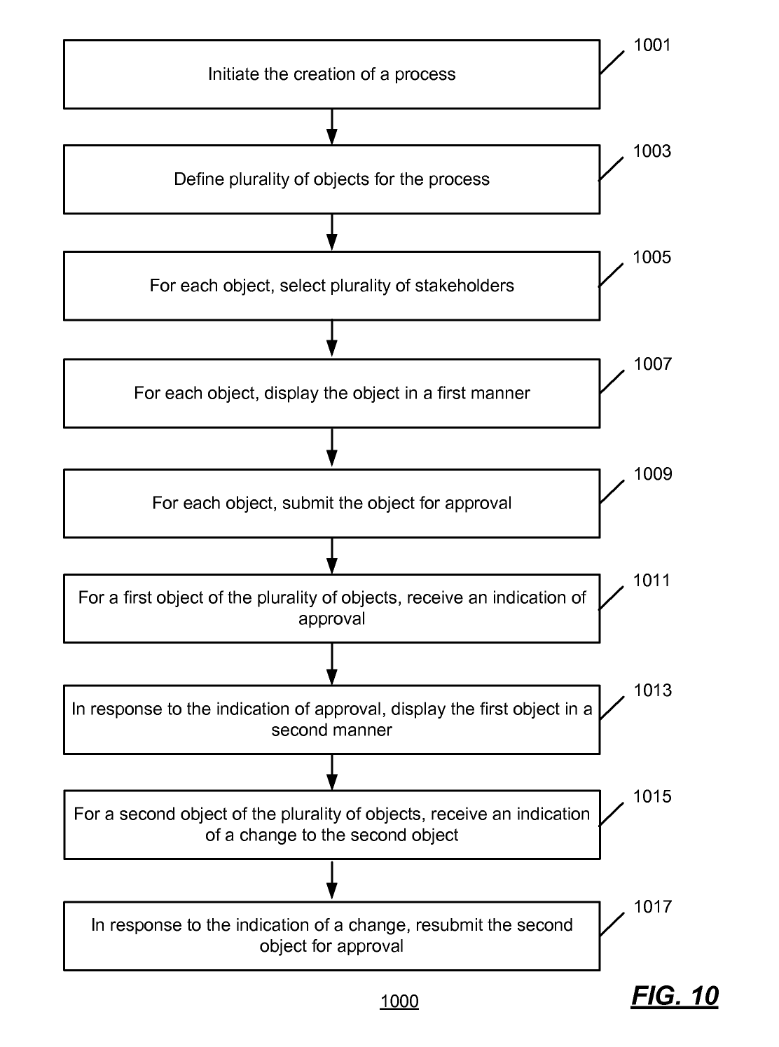

FIG. 10 is an illustration of a method 1000 for displaying a graphical representation of a process and one more associated objects. The method may be implemented by the execution engine 161 of the process engine 160.

At 1001, the creation of a process is initiated. The creation of the process may be initiated by a user of the client device 110 using a user interface provided by the execution engine 161. Depending on the implementation, the user may initiate the process by selecting a name for the process. In response, an entry for the process may be created in the process data 165 by the execution engine 161.

At 1003, a plurality of objects are defined for the process. The plurality of objects may be defined by the user using the user interface provided by the execution engine 161. For example, the user may select each object from a list of available objects provided by the execution engine 161.

At 1005, for each object, a plurality of stakeholders is selected. The plurality stakeholders 140 may be selected by the user using the user interface provided by the execution engine 161. The stakeholders 140 associated with an object may be those users who are ultimately responsible for implementing or producing the object such as engineers or programmers, for example. Depending on the implementation, the stakeholders 140 for an object may be selected by the user, or may be selected automatically by the execution engine 161 based on the type or department associated with the object.

At 1007, for each object, the object is displayed in a first manner. Each object may be displayed by the user interface provided by the execution engine 161 in a first manner that indicates that the object is under consideration and has not yet been approved. In some implementations, the first manner may be displaying the objects with dotted or broken lines. Other types of graphical indications may be used.

At 1009, for each object, the object is submitted for approval. The objects may be submitted for approval to the stakeholders 140 associated with each object by the execution engine 161. In some implementations, the execution engine 161 may submit an object for approval by creating a portal through which each of the stakeholders 140 can review and discuss the object. The stakeholders 140 may then use the portal to vote on the object, and to provide suggested changes to the object.

At 1011, for a first object of the plurality of objects an indication of approval is received. The indication of approval for the first object may be received by the execution engine 161 from one or more of the stakeholders 140 associated with the first object. The indication of approval may indicate that a majority of the stakeholders 140 associated with the object voted to approve the object.

At 1013, in response to the indication of approval, the first object is displayed in a second manner. The first object may be displayed in the second manner by the execution engine 161 to indicate the first object has been approved. The second manner may be displaying the first object using a complete or non-dotted line. Other types of graphical indications may be used.

At 1015, for a second object of the plurality of objects, an indication of a change to the second object is received. The indication of a change may be received by the execution engine 161 from one or more of the stakeholders 140 associated with the second object. The indication of a change may be change to an attribute or data flow associated with the second object, or may be a change to a task associated with the object.

In response to the indication of a change to the second object, the second object with the proposed change may be displayed to the user through a graphical overlay or layer placed over the original second object in the user interface. The user may then review the proposed changes by modeling the process 163 with the prosed change using the modeling engine 162 and comparing a generated score for the modified process with a generated score for the original process.

At 1017, in response to the indication of a change, the second object is resubmitted for approval. The second object with the proposed changes may be submitted for approval by the execution engine 161 to the stakeholders 140 using the generated portal as described above.

FIG. 11 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 11, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 11 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110.

Computing device 1100 typically includes a variety of computer readable media. Computer readable media can be any available media that can be accessed by the device 1100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communication connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
generating a process by a computing device;
generating a plurality of objects for the process by the computing device;
for each object of the plurality of objects, generating a plurality of tasks for the object by the computing device;
receiving a request to view a graphical representation of the process at the computing device;
in response to the request, determining a completion status for each task by the computing device;
for each object, determining a completion status for the object based on the determined completion statuses of the plurality of tasks generated for the object by the computing device; and
displaying a graphical representation of each object by the computing device, wherein the graphical representation of each object indicates the completion status of the object.

2. The method of claim 1, wherein determining a completion status for the object based on the plurality of tasks generated for the object further comprises determining the completion status based on the plurality of tasks associated with the object and business logic.

3. The method of claim 1, wherein the completion status of an object is indicated by a color of the graphical representation of the object.

4. The method of claim 1, further comprising received an indication of selection of one of the displayed graphical representations, and in response to the indication of selection, displaying graphical representations of each of the plurality of tasks generated for the object represented by the selected graphical representation.

5. The method of claim 4, wherein the graphical representations of each of the plurality of tasks indicate the completion statuses of each of the plurality of tasks.

6. The method of claim 1, wherein the process is associated with a plurality of data flows, and further comprising displaying a graphical representation of each of the data flows.

7. The method of claim 1, wherein determining a completion status of a task comprises determining the completion status of the task from a stakeholder associated with the task.

8. The method of claim 1, further comprising modeling the process, and based on the modeling, identifying a problem with at least one object of the plurality of objects, and changing the graphical representation of the at least one object to indicate the identified problem.

9. The method of claim 1, further comprising determining a score for the process based on the modeling.

10. A method comprising:
initiating the creation of a process by a computing device;
defining a plurality of objects for the process by the computing device;
for each object of the plurality of objects, selecting a plurality of stakeholders for the object by the computing device;
for each object of the plurality of objects, displaying the object in a first manner that indicates that the object is under consideration by the computing device;
for each object of the plurality of objects, submitting the object for approval to the plurality of stakeholders selected for the object by the computing device;
receiving an indication of approval for a first object of the plurality of objects from the plurality of stakeholders selected for the first object by the computing device,
in response to the indication of approval, displaying the first object in a second manner that indicates that the first object has been approved by the computing device;
receiving an indication of a change for a second object of the plurality of objects from the plurality of stakeholders selected for the second object by the computing device;
in response to the indication of a change for the second object, resubmitting the second object with the change for approval to the plurality of stakeholders selected for the second object by the computing device.

11. The method of claim 10, wherein each object comprises a plurality of tasks and further comprising:
for each object, receiving completion statuses for the plurality of tasks associated with the object from the plurality of stakeholders associated with the object; and
for each object, determining a completion status for the object based on the completion status of the tasks associated with the object

12. The method of claim 11, further comprising displaying each object of the process along with an indication of the completion status associated with the object.

12. The method of claim 11, receiving an indication of selection of at least one of the displayed objects, and in response to the selection, displaying each task associated with the at least one object.

13. The method of claim 11, wherein each task is displayed along with an indication of the completion status associated with the task.

14. The method of claim 10, wherein submitting the object for approval to the plurality of stakeholders selected for the object comprises generating a portal through which the plurality of stakeholders selected for the object can approve the object and suggest changes to the object.

15. The method of claim 10, further comprising in response to the indication of the change to the second object, displaying an overlay on the displayed second object, the overlay indicating the change to the second object.

16. The method of claim 10, further comprising modeling the process with the change to the second object, and based on the modeling, determining a score for the process.

17. A system comprising:
a computing device; and
an execution engine configured to:
generate a process, wherein the process comprises a plurality of objects and each object is associated with a plurality of stakeholders;
for each object of the plurality of objects, display the object in a first manner that indicates that the object is under consideration;
for each object of the plurality of objects, submit the object for approval to the plurality of stakeholders associated with the object;
for each object of the plurality of objects, receive an indication of approval for the object from the plurality of stakeholders associated with the object; and
in response to the indications of approval, for each object of the plurality of objects, display the object in a second manner that indicates that the object is approved.

18. The system of claim 17, wherein the execution engine configured to submit the object for approval to the plurality of stakeholders associated with the object comprises the execution engine configured to generate a portal through which the plurality of stakeholders associated with the object can approve the object and suggest changes to the object.

19. The system of claim 17, further comprising a modeling engine configured to model the process, and generate a score for the process based on the modeling.

20. The system of claim 17, wherein the execution engine comprises an application programming interface.
